(19) United States
(12) Patent Application Publication
(10) Pub. No.: US 2025/0009485 A1
(43) Pub. Date: Jan. 9, 2025

(54) METHOD FOR MANUFACTURING AN ORTHODONTIC APPLIANCE IN THE FORM OF AN ALIGNER

(71) Applicant: Hirsch Dynamics Holding AG, Wollerau (CH)

(72) Inventor: Markus HIRSCH, Wollerau (CH)

(73) Assignee: Hirsch Dynamics Holding AG, Wollerau (CH)

(21) Appl. No.: 18/890,902

(22) Filed: Sep. 20, 2024

Related U.S. Application Data
(63) Continuation of application No. PCT/EP2022/059767, filed on Apr. 12, 2022.

(51) Int. Cl. A61C 13/00; A61C 7/00

(52) U.S. Cl. CPC A61C 13/0006; A61C 7/002

(57) ABSTRACT

A method for manufacturing an orthodontic appliance in the form of an aligner, has the following steps: forming a sheet of plastic over a mold by deep drawing, trimming the deep-drawn plastic in a rough cut, wherein the plastic is arranged on the mold, moving the deep-drawn plastic together with the mold to a supporting surface by means of a robot, separating the deep-drawn plastic from the mold by means of the supporting surface, moving the deep-drawn plastic to a fixing device by means of the robot, wherein the fixing device is configured to fix the deep-drawn plastic at the fixing device and/or to prevent the deep-drawn plastic from shifting during trimming, and trimming the deep-drawn plastic in a fine cut to create the orthodontic appliance.

### CROSS REFERENCE TO RELATED APPLICATIONS

This application is a continuation of and Applicant claims priority under 35 U.S.C. § 120 of International Application No. PCT/EP2022/059767 filed on Apr. 12, 2022, The international application under PCT article 21(2) was published in English. The disclosure of the aforesaid International Application is hereby incorporated by reference.

### BACKGROUND OF THE INVENTION

### 1. Field of the Invention

The present invention relates to a method for manufacturing an orthodontic appliance in the form of an aligner. Furthermore, the present invention relates to a computer program product as well as an arrangement for manufacturing an orthodontic appliance in the form of an aligner comprising a mold for deep drawing the orthodontic appliance to be produced, a sheet of plastic to be formed in the shape of the orthodontic appliance and a robot for moving the mold and/or a deep-drawn plastic to produce the orthodontic appliance.

### 2. Description of the Related Art

The process of manufacturing aligners is complex since a variety of delicate process steps are required in order to ensure a high quality of the aligner that results in a sufficient treatment of a patient's dentition. Moreover, the rigidity of the thin aligner requires cautious handling during production to prevent plastic deformations of the aligner. Hence, usually trained technical staff and manual handling is needed to guarantee the proper manufacturing of the aligner during the value chain of the aligner.

A method for manufacturing an aligner is shown in International Application No. WO 2020/086563 A1, whereby a cutting device may be coupled to a robot in order to cut along an edge of the aligner instead of a trained technical staff.

A disadvantage of the prior art is that at least partial steps have to be performed manually and requires trained personal staff which results in a time-, cost- and personal-expensive production of orthodontic appliance which is not suitable for an ecological series production with a high number of manufactured orthodontic appliance per time interval. In particular, the process step of separating a deep-drawn plastic from the mold, moving the deep-drawn plastic and fixing the deep-drawn plastic during the manufacturing process are not feasible without the need of trained technical staff since the geometry and elastic compressibility constitute great hurdles for handling without wrecking the shape of the orthodontic appliance.

### SUMMARY OF THE INVENTION

It is an object of the present invention to simplify and accelerate the manufacture of orthodontic appliances by a method and a system that are appropriate to eliminate at least some of the disadvantages of the prior art, whereby in particular a series production of orthodontic appliances is automatically facilitated without the requirement of manual steps of trained technical staff—particularly with respect to the sensitive process steps of separation, movement and fixation of the orthodontic appliance to be produced to improve the value chain with respect to precision, quality, reproduction and/or efficiency.

The object of the present invention is accomplished by a method having the following steps:
forming a sheet of plastic over a mold by deep drawing
trimming the deep-drawn plastic in a rough cut, whereby the plastic is arranged on the mold
moving the deep-drawn plastic together with the mold to a supporting surface by means of a robot
separating the deep-drawn plastic from the mold by means of the supporting surface
moving the deep-drawn plastic to a fixing device by means of the robot, whereby the fixing device is configured to fix the deep-drawn plastic at the fixing device and/or to prevent the deep-drawn plastic from shifting during trimming
trimming the deep-drawn plastic in a fine cut to create the orthodontic appliance.

This enables an automatic and efficient manipulation of the deep-drawn plastic from forming to post-processing, whereby the method is automatized such that no trained technical staff is required for series production. The method is preferably automatized, particularly preferably fully automatized by means of the robot and/or a further robot.

Trimming the deep-drawn plastic in the fine cut can be performed on a separated or the same supporting surface as used for separation.

Due to the fixing device—used for trimming the deep-drawn plastic in the fine cut—the deep-drawn plastic can be prevented from shifting without manual steps.

Due to the supporting surface the process step of separation is enabled without the need of manual steps, whereby the supporting surface can for example be used to blow the deep-drawn plastic off the mold, orientate the deep-drawn plastic defined via a plane contact surface or adjustment devices in particular for manipulation with a gripper, and/or fix the mold to the supporting surface during separation.

As stated above, protection is also sought after a computer program product which, when the program is executed by a control unit causes the control unit to carry out such a method.

Preferably, the computer program product is stored on a, preferred non-volatile, data carrier and/or transmitted via a data carrier signal.

As stated above, protection is also sought after an arrangement for manufacturing an orthodontic appliance in the form of an aligner comprising a mold for deep drawing the orthodontic appliance to be produced, a sheet of plastic to be formed in the shape of the orthodontic appliance and a robot for moving the mold and/or a deep-drawn plastic to produce the orthodontic appliance, characterized in that the robot comprises a control unit configured to perform such a method.

Preferred embodiments of the present invention are defined below. Features of the method are applicable with respect to the product and vice versa.

In a preferred embodiment of the present invention, it is provided that at least one first flap is formed during forming of the sheet of plastic within the deep-drawn plastic, whereby the at least one first flap is arranged at least partially in an area between the orthodontic appliance to be produced and/or sticking out of surrounding plastic material opposite to a deep drawing direction, whereby it is preferably provided that the at least one first flap is essentially T-shaped.

By means of the at least one first flap, a defined position at the supporting surface can be ensured and/or the deep-drawn plastic can be separated from the mold—for example by compressed air, whereby the at least one first flap can be used in a further dual function to provide a defined gripping area for a gripper.

In a preferred embodiment of the present invention, it is provided that at least one second flap is cut out of the deep-drawn plastic during trimming in the rough cut, whereby the at least one second flap is arranged at a central region and/or at a free end of the orthodontic appliance to be produced and/or extending orthogonal to a deep drawing direction, whereby it is preferably provided that the at least one second flap comprises a thickness that is essentially equal to a material thickness of the sheet of plastic.

The at least one second flap can be used to flatly arrange the deep-drawn plastic at the supporting surface and can be used in a dual function to separate the deep-drawn plastic from the mold by elastically deform the deep-drawn plastic by means of the at least one second flap—for example by means of a needle gripper.

It is preferably provided that the robot comprises a gripper and a control unit, whereby a path planning is stored in the control unit, whereby a movement of the robot is executed by means of the control unit on basis of the path planning, whereby it is preferably provided that the gripper is applied with a maximum closing force between 15 Newton and 30 Newton by means of the control unit and/or is referenced by means of a reference tip prior to movement and/or grasps the deep-drawn plastic in a central region, particularly preferred in an area of the center of gravity.

The control unit enables an automatic handling and/or processing of the orthodontic appliance to be produced without requiring manual steps of movement and/or machining.

In a preferred embodiment of the present invention, it is provided that the gripper comprises a grip enhancement device and/or is in the form of a parallel gripper, a vacuum gripper, a three-arm gripper, a needle gripper and/or an adhesive gripper.

Since it can be cumbersome to grasp the deep-drawn plastic, grip enhancement devices can increase a friction that prevent the deep-drawn plastic from falling off the gripper. Adhesive grippers can comprise sticky surfaces and/or temporary bonding agents or rather gripping means, whereby negative pressure used by a vacuum gripper is applicable as well.

It is preferably provided that the fixing device comprises wax and/or modelling clay, preferred within a fixing mold of the fixing device.

The deep-drawn plastic can be partially pressed into the wax or modelling clay to prevent the deep-drawn plastic from shifting during processing.

In a preferred embodiment of the present invention, it is provided that the fixing device is in the form of an insert tray, two sticks pressing the orthodontic appliance to be produced against the supporting surface, preferred in connection with a stop arranged on the supporting surface, and/or a foam, preferred in connection with a magnet pressing the orthodontic appliance to be produced against the foam.

If the deep-drawn plastic is located in an insert tray, held by means of sticks or pressed onto a foam, slipping of the deep-drawn plastic during processing like trimming in the fine cut or grinding can be prevented.

It is preferred provided that the robot grasps the rough cut deep-drawn plastic by means of the at least one first flap during movement.

Since the at least one first flap constitutes a zonal elevation, it can be used as a gripping means for the gripper to move the deep-drawn plastic—if applicable together with the mold.

In a preferred embodiment of the present invention, it is provided that the deep-drawn plastic is arranged in a first positional condition during the rough cut and in a second positional condition during trimming of the deep-drawn plastic in the fine cut rotated about 180 degrees with respect to a deep drawing direction and the first positional condition, whereby it is preferred provided that the rotation is caused by means of the robot.

Since in general the mold is removed for the trimming in the fine cut in order to finish the cutting surface for treatment of a patient's dentition, the deep-drawn plastic is turned over with respect to a state arranged on the mold and fixed within the fixing device to be accessed by trimming, cutting or grinding means.

It is preferably provided that the at least one second flap is arranged on the supporting surface during separation and/or used for separation, preferred by means of the robot.

In a preferred embodiment of the present invention, it is provided that the deep-drawn plastic is elastically deformed orthogonal to a deep drawing direction during separation by means of the at least one second flap, preferred by means of the robot.

The at least one second flap can be used as a gripping device for spreading the deep-drawn plastic to further separate it from the mold.

It is preferably provided that the at least one first flap is blown at during separation in an opposite direction with respect to a deep drawing direction through at least one aperture of the supporting surface above which the at least one first flap is at least partially arranged on during separation.

In general, the mold is fixed onto the supporting surface during separation, whereby in this embodiment, the separation of the deep-drawn plastic from the mold is—alternative or in addition to an elastic deformation of the deep-drawn plastic—generated by compressed air for example.

In a preferred embodiment of the present invention, it is provided that a preferably capacitive sensor is used to detect a successful separation, preferably arranged at the supporting surface and/or if applicable underneath at least one first flap.

The sensor can ensure that the separation is completed.

It is preferably provided that the mold is fixed at the supporting surface during separation by means of
a preferably L-shaped indentation of the mold corresponding to a preferably L-shaped fixation device, which is preferably a barb or barb plate, extending opposite to a deep drawing direction beyond the supporting surface, whereby it is preferred provided that the fixation device is movable with respect to the supporting surface, particularly preferably by means of an actuator and/or a return spring, and/or
a stationary fixation pin extending, preferably sloping, opposite to a deep drawing direction beyond the supporting surface and a movable fixation pin movable through an opening of the supporting surface in a preferably sloping direction opposite to the deep drawing direction, whereby it is preferably provided that the movable fixation pin is arranged on the mold after arranging the mold at least partially around the stationary fixation pin, and/or
a thread arranged inside the mold and a bolt extending through the supporting surface corresponding the thread and/or
a groove arranged at the mold and a fastening device, preferably cuboid, insertable to the groove and rotatable in a direction orthogonal to a deep drawing direction to mount the mold onto the supporting surface.

These constructional designs enable a separation of the deep-drawn plastic from the mold without moving the mold during separation.

In a preferred embodiment of the present invention, it is provided that the deep-drawn plastic is levered with respect to the mold during separation, preferred through a cardioid movement, particularly preferably by means of the robot.

In addition or alternative to an elastic deformation and/or the use of compressed air, the deep-drawn plastic can be separated by means of the robot or a further robot.

It is preferably provided that the rough cut and/or the fine cut are performed by means of a die cutter, a laser, an ultra-sonic cutter, a water cut jet, a milling tool, a cutting blade and/or a soldering iron, preferred of a further robot.

A precise cutting surface is essential with respect to a high comfort during treatment of the patient's dentition by means of the aligner.

In a preferred embodiment of the present invention, it is provided that in a subsequent step, the orthodontic appliance is grinded by means of a grinding tool, preferably of a further robot.

It is preferably provided that the robot moves the orthodontic appliance to be produced, and if applicable the mold, between a deep drawing station, a rough cut station, a separation station, a fine cut station, a grinding station, a post-processing station and/or a packaging station.

The movement can be done by means of a rotary table, a conveyor belt or a further robot as well, whereby manual handling is in general not required.

In a preferred embodiment of the present invention, it is provided that in a subsequent step, the orthodontic appliance is irradiated by means of UV lamp and/or packaged hermetically, preferred by means of a further robot.

This can prevent bacterial growth till delivery and usage to/by the patient.

It is preferably provided that prior to separation and/or subsequent to separation, at least one marker to identify the orthodontic appliance is applied on the orthodontic appliance or the orthodontic appliance to be produced.

Thus, even in series production with a high number of produced aligners, the assignment is facilitated and can be performed automatically.

In a preferred embodiment of the present invention, it is provided that a material thickness of the sheet of plastic and/or the orthodontic appliance is between 0.5 mm and 0.75 mm.

Hence, a correction of the patient's dentition starting from a first occlusal condition to a second occlusal condition is enabled with a defined force that is comfortable for the patient during treatment.

It is preferably provided that a first protective layer and/or a second protective layer is arranged at the sheet of plastic, whereby by means of the robot the first protective layer is removed from the sheet of plastic prior to deep drawing and/or the second protective layer is removed from the deep-drawn plastic subsequent to separation, trimming the deep-drawn plastic in the fine cut and/or post-processing by means of the robot and/or if applicable a further robot.

The first protective layer can be used to prevent the sheet of plastic from contamination. The second protective layer can be used to prevent the deep-drawn plastic from fading such that the aligner remains clear and provides an improved aesthetic appearance during treatment.

In a preferred embodiment of the present invention, it is provided that the robot is in the form of a robot arm, a delta robot, a five-axes or a six-axes robot, whereby preferably a rotary table or a conveyor belt for the mold and/or the deep-drawn plastic is provided.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIGS. 1A and 1B show an orthodontic appliance in the form of an aligner on a mold to be manufactured by a method of the present invention in a schematic illustration in a perspective view and a sheet of plastic to form the orthodontic appliance by the method;

FIGS. 2A and 2B show two fixing devices for holding a deep-drawn plastic at the fixing devices as well as a schematical illustration of an arrangement for manufacturing the orthodontic appliance;

FIGS. 3A and 3B show a deep-drawn plastic arranged on a supporting surface for separation from a mold;

FIGS. 4A, 4B, 4C, and 4D show four preferred embodiments of means to fix the mold onto the supporting surface during separation of a deep-drawn plastic from a mold; and

FIGS. 5A, 5B, and 5C show three further fixing devices for holding a deep-drawn plastic during trimming the deep-drawn plastic in a fine cut for instance.

### DETAILED DESCRIPTION OF PREFERRED EMBODIMENTS

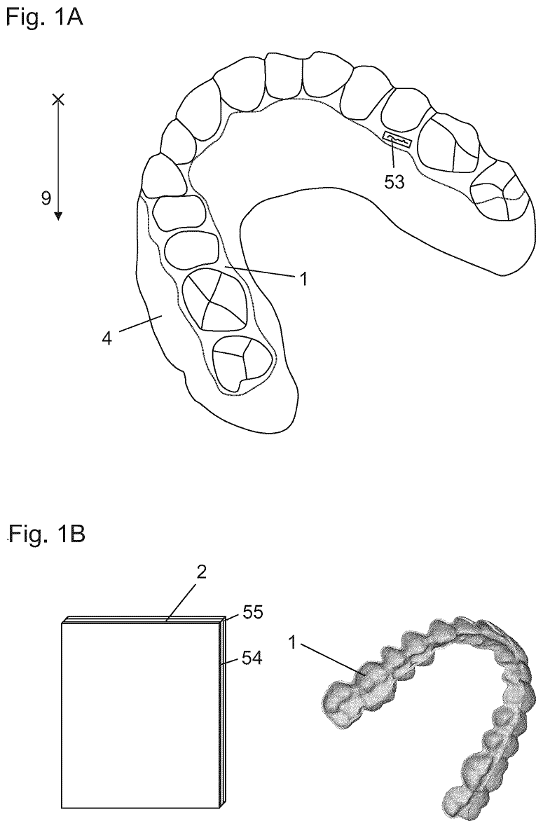

FIG. 1A discloses a mold 4 over which a sheet of plastic 2 is deep-drawn. The deep-drawn plastic 3 is further processed to produce an orthodontic appliance 1 in the form of an aligner.

Prior to separation, a marker 53 is applied to the orthodontic appliance 1 to be produced in order to identify the orthodontic appliance 1. The marker 53 can in general be applied subsequent to separation—for example on the produced orthodontic appliance 1.

FIG. 1B shows on the left side a sheet of plastic 2 comprising a first protective layer 54 and a second protective layer 55 arranged at the sheet of plastic 2. After competition of the method for manufacturing the orthodontic appliance 1, the orthodontic appliance 1 shown on the right side of the illustration is provided for treatment of a patient.

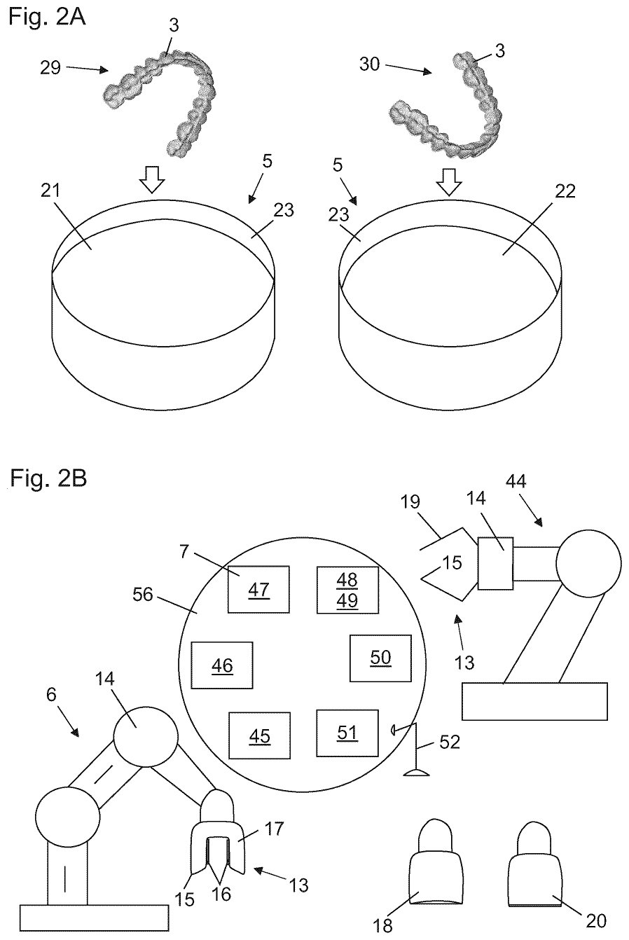

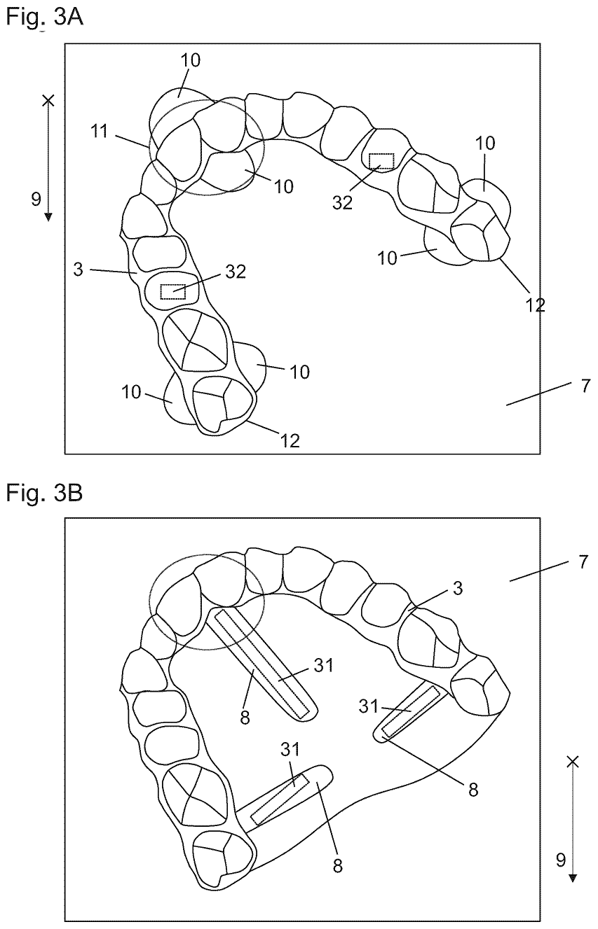

The method for manufacturing the orthodontic appliance 1 in the form of an aligner can be exemplified as follows: The sheet of plastic 2 is formed over the mold 4 by deep drawing, the deep-drawn plastic 3 is trimmed in a rough cut, whereby the plastic 2, 3 is arranged on the mold 4, the deep-drawn plastic 3 is moved together with the mold 4 to a supporting surface 7 by means of a robot 6 (cf. FIG. 2B), the deep-drawn plastic 3 is separated from the mold 4 by means of the supporting surface 7 (cf. FIG. 3B), the deep-drawn plastic 3 is moved by the robot 6 or further robot 44 to a fixing device 5 without the mold 4—whereby the fixing device 5 fixes the deep-drawn plastic 3 at the fixing device and prevents the deep-drawn plastic 3 from shifting during trimming—and the deep-drawn plastic 3 is trimmed in a fine cut to create the orthodontic appliance 1.

By means of the robot 6 or a further robot 44, the first protective layer 54 can be removed from the sheet of plastic 2 prior to deep drawing. Analogously the second protective layer 55 can be removed from the deep-drawn plastic 3 subsequent to separation, trimming the deep-drawn plastic 3 in the fine cut or post-processing by means of the robot 6 and/or the further robot 44.

In a subsequent step, the orthodontic appliance 5 is grinded by means of a grinding tool of the robot 6 or the further robot 44, whereby this step is not necessary in general.

A material thickness of the sheet of plastic 2 and the orthodontic appliance 5 is between 0.5 mm and 0.75 mm.

FIG. 2A discloses on the left side of the illustration a fixing device 5 comprising wax 21 within a fixing mold 23 of the fixing device 5. The wax 21 is used to arrange the deep-drawn plastic 3 partially within the wax 21.

On the right side, modelling clay 22 is used within a fixing mold 23 to hold the deep-drawn plastic 3 at the fixing device 5.

The deep-drawn plastic 3 is arranged in a first positional condition 29 during the rough cut that is shown on the right side of the illustration since the deep-drawn plastic 3 is in general arranged on the mold 4 during the rough cut. The deep-drawn plastic 3 is arranged in in a second positional condition 30 shown on the left side during trimming of the deep-drawn plastic 3 in the fine cut or during post-processing, whereby the second positional condition is rotated about 180 degrees with respect to a deep drawing direction 9 (cf. FIG. 1A) and the first positional condition 29. Hence, the deep-drawn plastic 3 is rotated by means of the robot 6 or further robot 44 prior to the partial arrangement within the modelling clay 22.

FIG. 2B discloses an arrangement for manufacturing the orthodontic appliance 1 in the form of an aligner comprising the mold 4 for deep drawing of the orthodontic appliance 1 to be produced and the sheet of plastic 2 to be formed in the shape of the orthodontic appliance 1 (not shown in the illustration) by the method of the present invention.

A robot 6 is used for moving the mold 4 and the deep-drawn plastic 3 to produce the orthodontic appliance 1, whereby the robot 6 comprises a control unit 14 configured to perform the method for producing the orthodontic appliance 1. A further robot 44 is provided that can be used as a part of the robot 6 or in addition to the robot 6.

The robot 6 moves the orthodontic appliance 5 to be produced and the mold 4 between a deep drawing station 45, a rough cut station 46, a separation station 47, a fine cut station 48, a grinding station 49, a post-processing station 50 and a packaging station 51. The fine cut station 48 and the grinding station 49 are combined in one station. The separation station 47 comprises the supporting surface 7 to separate the deep-drawn plastic 3 from the mold 4. The number of stations is in general arbitrary, whereby some stations can be omitted if applicable.

The orthodontic appliance 5 is irradiated by means of UV lamp 52 and packaged hermetically by means of the robot 6 or a further robot 44 in a subsequent step. This is done at the packaging station 51, whereby the post-processing station 50 can be used as well (also for applying the marker 53 for instance).

Since the method shall facilitate a series production of orthodontic appliances 1, the robot 6 comprises a gripper 13 and a control unit 14, whereby a path planning is stored in the control unit 14. A movement of the robot 6 is executed by means of the control unit 14 on basis of the path planning, whereby the gripper 13 is applied with a maximum closing force between 15 Newton and 30 Newton by means of the control unit 14. A closing force can be adapted to a different force interval, if applicable. The robot 6 and the further robot 44 are referenced by means of a reference tip 15 prior to movement which is located at a free end of the gripper 13. The reference tip 15 can be in general a separate component that is picked up by the robot 6 or the further robot 44.

The gripper 13 of the robot 6 comprises a grip enhancement device 16 and is in the form of a parallel gripper 17. The further robot 44 comprises a gripper 13 in the form of a needle gripper 19 to apply a spreading force to the deep-drawn plastic 3 for instance.

Two further grippers 13 in the form of a vacuum gripper 18 and an adhesive gripper 20 are positioned to be used by the robot 6 or the further robot 44 if applicable. In general, a three-arm gripper can be used as well.

The robot 6 or further robot 44 grasps the deep-drawn plastic 3, whereby a secure movement can be provided if the deep-drawn plastic 3 is gripped in a central region 11 or at an area of the center of gravity.

A computer program product is used for the robot 6 or the further robot 44 which, when the program is executed by the control unit 14 causes the control unit 14 to automatically carry out the method for manufacturing the orthodontic appliance 1.

The robot 6 and the further robot 44 are in the form of a robot arm as five-axes robot, whereby a delta robot or a six-axes robot can be used as well.

A rotary table 56 for the mold 4 and/or the deep-drawn plastic 3 is provided to move the orthodontic appliance 1 to be produced during the method (not necessary in general), whereby a conveyor belt can be used as well.

FIGS. 3A and 3B disclose the geometry of the deep-drawn plastic after the rough cut, whereby the forms can be used alternatively or in combination.

FIG. 3A shows that the deep-drawn plastic 3 comprises six second flaps 10 that are cut out of the deep-drawn plastic 3 during trimming in the rough cut, whereby the number of second flaps 10 is in general arbitrary. Two second flaps 10 are arranged at a central region 11 and four second flaps 10 are arranged at both free ends 12 of the orthodontic appliance 5 to be produced, whereby the second flaps 10 extend orthogonal to a deep drawing direction 9. The second flaps 10 comprise a thickness that is equal to a material thickness of the sheet of plastic 2 or rather the deep-drawn plastic 3.

The second flaps 10 can be used to provide a two-dimensional contacting surface with the supporting surface 7 and to elastically deform the deep-drawn plastic 3 orthogonal to a deep drawing direction 9 during separation by means of a needle gripper 19 that spreads the second flaps 10 automatically for separation from the mold 4. The second flaps 10 can comprise openings for the robot 6 or further robot 44, whereby an at least partial penetration of the second flaps 10 is applicable as well.

A capacitive sensor 32 is used to detect a successful separation of the deep-drawn plastic 3 with respect to the mold 4 which is arranged on the supporting surface 7. The sensor 32 can be for example placed underneath a first flap 8 as well.

FIG. 3B discloses a deep-drawn plastic 3 with three first flaps 8 that are generated during forming of the sheet of plastic 2 within the deep-drawn plastic 3. The first flaps 8 are spatially separated and arranged in T-form, whereby a single T-shaped first flap 8 is applicable as well.

The first flaps 8 are arranged completely in an area between the free ends 12 and the central region 11 of the orthodontic appliance 1 to be produced and stick out of surrounding plastic material opposite to the deep drawing direction 9.

The first flaps 8 are arranged above three apertures 31 of the supporting surface 7 (a single aperture 31 is applicable as well) in order to be blown at during separation in opposite direction with respect to the deep drawing direction 9 through the apertures 31. Air can move past the apertures 31 inside the cavities that are constituted by the first flaps 8 to lift the deep-drawn plastic 3 up while the mold 4 is stationary.

The apertures 31 can comprise in general adjustment means to place the first flaps 8 over the apertures 31 correctly, whereby the second flap 10 is arranged on the supporting surface 7 during separation and used for separation for example by means of a compressed air device of the robot 6 or further robot 44.

The robot 6 grasps the rough cut deep-drawn plastic 3 by means first flaps 8 during movement. Hence, the first flaps 8 can be used in a dual function for automatic separation and automatic movement. The deep-drawn plastic 3 can be levered—in a cardioid movement for instance—with respect to the mold 4 during separation by means of the robot 6 or further robot 44.

A sensor 32 can be used for detection of successful separation.

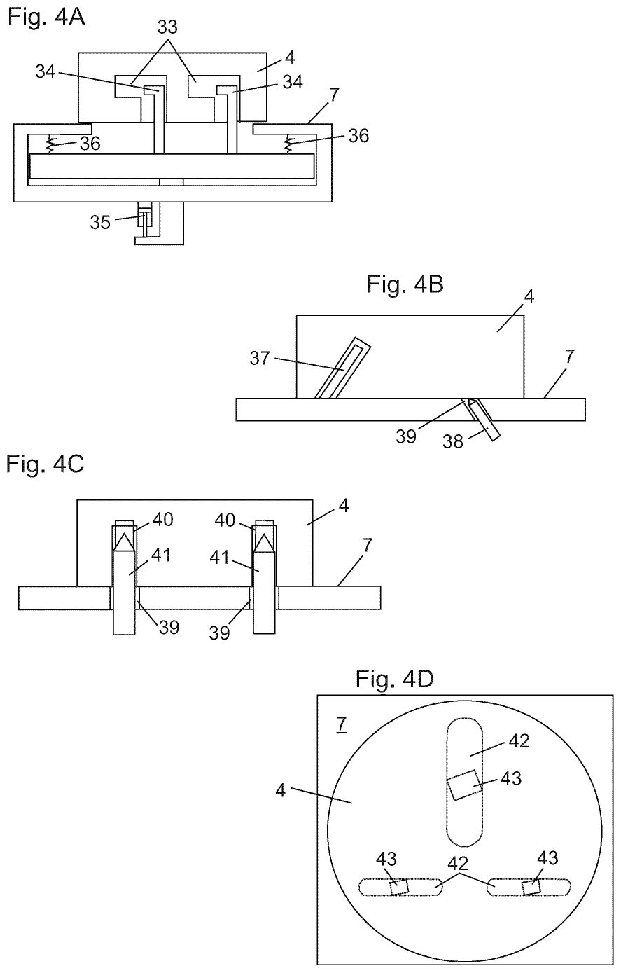

FIGS. 4A to 4D disclose different embodiments for fixing the mold 4 to the supporting surface 7 during separation.

FIG. 4A shows that the mold 4 is fixed at the supporting surface 7 during separation by means of two L-shaped indentations 33 within the mold 4 corresponding to two L-shaped fixation devices 34 comprised by a barb plate.

The fixation devices 34 extend opposite to a deep drawing direction 9 beyond the supporting surface 7, whereby the fixation devices 34 are movable with respect to the supporting surface 7 by means of an actuator 35 in the form of a hydraulic or pneumatic cylinder and a return spring 36 for reversing a movement of the fixation devices 34.

FIG. 4B discloses a stationary fixation pin 37 extending sloping opposite to a deep drawing direction 9 beyond the supporting surface 7 into an undercut of the mold 4 and a movable fixation pin 38 movable through an opening 39 of the supporting surface 7 in sloping direction opposite to the deep drawing direction 9.

The movable fixation pin 38 is arranged on the mold 4 after arranging the mold 4 at around the stationary fixation pin 37, whereby the fixation pin 38 can be pressed onto or in the mold 4.

FIG. 4C shows a thread 40 arranged inside the mold 4 and a bolt 41 with a corresponding thread extending through the supporting surface 4 corresponding the thread 40 to fasten the mold 4 to the supporting surface 4 during separation.

FIG. 4D discloses three grooves 42 formed within the mold 4 and three fastening devices 43 in the form of cuboids (other shapes like triangles are applicable as well) insertable to the grooves 42. The number of grooves 42 and fastening devices 43 is in general arbitrary, whereby the fastening devices 43 are rotatable in a direction orthogonal to a deep drawing direction 9 to secure the mold 4 with respect to the supporting surface 7.

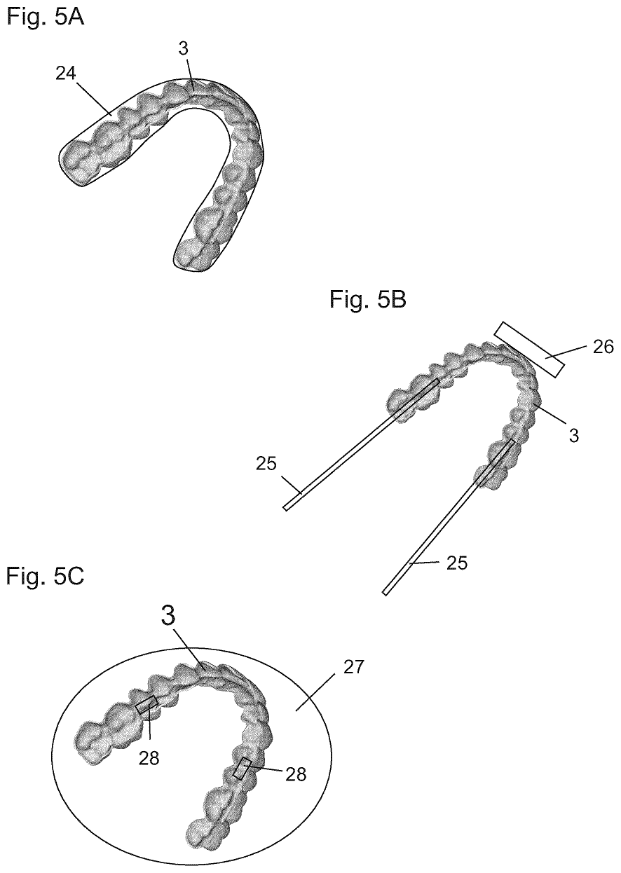

FIGS. 5A to 5C disclose further possibilities for fixing devices 5 in combination or as alternatives to the fixing devices 5 shown in FIG. 2A.

FIG. 5A shows that a fixing device 5 is in the form of an insert tray 24, that can be produced for example via 3D-printing. The deep-drawn plastic 3 can be located inside the insert tray 24 in order to facilitate the trimming in the fine cut or post-processing process steps like grinding or marking.

FIG. 5B discloses a fixing device 5 in the form of two sticks 25 by means the orthodontic appliance 5 to be produced can be pressed against the supporting surface 7. To prevent lateral movements or tilting of the deep-drawn plastic 3, a stop 26 is arranged on the supporting surface 7.

In FIG. 5C, a fixing device 5 is presented in the form of a layer of foam 27 in which the deep-drawn plastic 3 is pressed for trimming or post-processing. Due to a compressibility of the foam 27, the deep-drawn plastic 3 can be held within the foam 27 during the method.

For the rough cut and the fine cut, cutting devices like a die cutter, a laser, an ultra-sonic cutter, a water cut jet, a milling tool, a cutting blade or a soldering iron can be used which can be controlled by the robot 6 or the further robot 44.

Although only a few embodiments of the present invention have been shown and described, it is to be understood that many changes and modifications may be made thereunto without departing from the spirit and scope of the invention.

What is claimed is:

1. A method for manufacturing an orthodontic appliance (1) in the form of an aligner, comprising the following steps:
forming a sheet of plastic (2) over a mold (4) by deep drawing,
trimming the deep-drawn plastic (3) in a rough cut, wherein the plastic (2, 3) is arranged on the mold (4),
moving the deep-drawn plastic (3) together with the mold (4) to a supporting surface (7) by means of a robot (6),
separating the deep-drawn plastic (3) from the mold (4) by means of the supporting surface (7),
moving the deep-drawn plastic (3) to a fixing device (5) by means of the robot (6), wherein the fixing device (5) is configured to fix the deep-drawn plastic at the fixing device (5) and/or to prevent the deep-drawn plastic (3) from shifting during trimming,
trimming the deep-drawn plastic (3) in a fine cut to create the orthodontic appliance (1).

2. The method according to claim 1, wherein at least one first flap (8) is formed during forming of the sheet of plastic (2) within the deep-drawn plastic (3), wherein the at least one first flap (8) is arranged at least partially in an area between the orthodontic appliance (1) to be produced and/or sticking out of surrounding plastic material opposite to a deep drawing direction (9), wherein it is preferably provided that the at least one first flap (8) is essentially T-shaped.

3. The method according to claim 1, wherein at least one second flap (10) is cut out of the deep-drawn plastic (3) during trimming in the rough cut, wherein the at least one second flap (10) is arranged at a central region (11) and/or at a free end (12) of the orthodontic appliance (5) to be produced and/or extending orthogonal to a deep drawing direction (9), wherein it is preferably provided that the at least one second flap (10) comprises a thickness that is essentially equal to a material thickness of the sheet of plastic (2).

4. The method according to claim 1, wherein the robot (6) comprises a gripper (13) and a control unit (14), wherein a path planning is stored in the control unit (14), wherein a movement of the robot (6) is executed by means of the control unit (14) on basis of the path planning, wherein it is preferably provided that the gripper (13) is applied with a maximum closing force between 15 Newton and 30 Newton by means of the control unit (14) and/or is referenced by means of a reference tip (15) prior to movement and/or grasps the deep-drawn plastic (3) in a central region (11), particularly preferred in an area of the center of gravity.

5. The method according to claim 4, wherein the gripper (13) comprises a grip enhancement device (16) and/or is in the form of a parallel gripper (17), a vacuum gripper (18), a three-arm gripper, a needle gripper (19) and/or an adhesive gripper (20).

6. The method according to claim 1, wherein the fixing device (5) comprises wax (21) and/or modelling clay (22), preferably within a fixing mold (23) of the fixing device (5).

7. The method according to claim 1, wherein the fixing device (5) is in the form of an insert tray (24), two sticks (25) pressing the orthodontic appliance (5) to be produced against the supporting surface (7), preferably in connection with a stop (26) arranged on the supporting surface (7), and/or a foam (27), preferably in connection with a magnet (28) pressing the orthodontic appliance (5) to be produced against the foam (27).

8. The method according to claim 1, wherein the robot (6) grasps the rough cut deep-drawn plastic (3) by means of the at least one first flap (8) during movement.

9. The method according to claim 1, wherein the deep-drawn plastic (3) is arranged in a first positional condition (29) during the rough cut and in a second positional condition (30) during trimming of the deep-drawn plastic (3) in the fine cut rotated about 180 degrees with respect to a deep drawing direction (9) and the first positional condition (29), wherein it is preferably provided that the rotation is caused by means of the robot (6).

10. The method according to claim 1, wherein the at least one second flap (10) is arranged on the supporting surface (7) during separation and/or used for separation, preferably by means of the robot (6).

11. The method according to claim 10, wherein the deep-drawn plastic (3) is elastically deformed orthogonal to a deep drawing direction (9) during separation by means of the at least one second flap (10), preferably by means of the robot (6).

12. The method according to claim 1, wherein the at least one first flap (8) is blown at during separation in opposite direction with respect to a deep drawing direction (9) through at least one aperture (31) of the supporting surface (7) above which the at least one first flap (8) is at least partially arranged on during separation.

13. The method according to claim 1, wherein a preferably capacitive sensor is used to detect a successful separation, preferably arranged at the supporting surface (7) and/or if applicable underneath at least one first flap (8).

14. The method according to claim 1, wherein the mold (4) is fixed at the supporting surface (7) during separation by means of
a preferably L-shaped, indentation (33) of the mold (4) corresponding to a preferably L-shaped, fixation device (34), preferably a barb or barb plate, extending opposite to a deep drawing direction (9) beyond the supporting surface (7), wherein it is preferably provided that the fixation device (34) is movable with respect to the supporting surface (7), particularly preferably by means of an actuator (35) and/or a return spring (36), and/or
a stationary fixation pin (37) extending, preferred sloping, opposite to a deep drawing direction (9) beyond the supporting surface (7) and a movable fixation pin (38) movable through an opening (39) of the supporting surface (7) in, preferred sloping, direction opposite to the deep drawing direction (9), whereby it is preferred provided that the movable fixation pin (38) is arranged on the mold (4) after arranging the mold (4) at least partially around the stationary fixation pin (37), and/or
a thread (40) arranged inside the mold (4) and a bolt (41) extending through the supporting surface (4) corresponding the thread (40) and/or
a groove (42) arranged at the mold (4) and a fastening device (43), preferred cuboid, insertable to the groove (42) and rotatable in a direction orthogonal to a deep drawing direction (9) to mount the mold (4) onto the supporting surface (7).

15. The method according to claim 1, wherein the deep-drawn plastic (3) is levered with respect to the mold (4) during separation, preferred through a cardioid movement, particularly preferred by means of the robot (6).

16. The method according to claim 1, wherein the rough cut and/or the fine cut are performed by means of a die cutter, a laser, an ultra-sonic cutter, a water cut jet, a milling tool, a cutting blade and/or a soldering iron, preferably of a further robot (44).

17. The method according to claim 1, wherein in a subsequent step, the orthodontic appliance (5) is grinded by means of a grinding tool, preferably of a further robot (44).

18. The method according to claim 1, wherein the robot (6) moves the orthodontic appliance (5) to be produced, and if applicable the mold (4), between a deep drawing station (45), a rough cut station (46), a separation station (47), a fine cut station (48), a grinding station (49), a post-processing station (50) and/or a packaging station (51).

19. The method according to claim 1, wherein in a subsequent step, the orthodontic appliance (5) is irradiated by means of UV lamp (52) and/or packaged hermetically, preferably by means of a further robot (44).

20. The method according to claim 1, wherein prior to separation and/or subsequent to separation, at least one marker (53) to identify the orthodontic appliance (5) is applied on the orthodontic appliance (5) or the orthodontic appliance (5) to be produced.

21. The method according to claim 1, wherein a material thickness of the sheet of plastic (2) and/or the orthodontic appliance (5) is between 0.5 mm and 0.75 mm.

22. The method according to claim 1, wherein a first protective layer (54) and/or a second protective layer (55) is arranged at the sheet of plastic (2), wherein by means of the robot (6) the first protective layer (54) is removed from the sheet of plastic (2) prior to deep drawing and/or the second protective layer (55) is removed from the deep-drawn plastic (3) subsequent to separation, trimming the deep-drawn plastic (3) in the fine cut and/or post-processing by means of the robot (6) and/or if applicable a further robot (44).

23. The method according to claim 1, wherein the robot (6) is in the form of a robot arm, a delta robot, a five-axes or a six-axes robot, whereby preferably a rotary table (56) or a conveyor belt for the mold (4) and/or the deep-drawn plastic (3) is provided.

24. A computer program product which, when the program is executed by a control unit (14) causes the control unit (14) to carry out the method of claim 1.

25. An arrangement for manufacturing an orthodontic appliance (1) in the form of an aligner comprising a mold (4) for deep drawing the orthodontic appliance (1) to be produced, a sheet of plastic (2) to be formed in the shape of the orthodontic appliance (1) and a robot (6) for moving the mold (4) and/or a deep-drawn plastic (3) to produce the orthodontic appliance (1), wherein the robot (6) comprises a control unit (14) configured to perform the method of claim 1.
